(19) United States
(12) Patent Application Publication
(10) Pub. No.: US 2004/0068594 A1
(43) Pub. Date: Apr. 8, 2004

(54) Method and apparatus for data bus inversion

(76) Inventors: Anthony Asaro, Toronto (CA); Stanislav Sokorac, Toronto (CA)

Correspondence Address: VEDDER PRICE KAUFMAN & KAMMHOLZ, 222 N. LASALLE STREET, CHICAGO, IL, 60601, US

(21) Appl. No.: 10/266,775

(22) Filed: Oct. 8, 2002

(51) Int. Cl. G06F 13/00

(52) U.S. Cl. 710/104

(57) ABSTRACT

A method and apparatus for data bus inversion provides for a data bus having a data bus size value, wherein the data bus size value represents the number of bits transferred across the bus in a single transmission, for receiving a new data value having a plurality of new data bits. The method and apparatus further provide for determining the change bit value by comparing the different new data bits with a plurality of current transmission data bits from a current data value. Furthermore, when the change bit value is equal to one-half the data bus size value, the method and apparatus provides for adjusting at least the plurality of new data bits and/or a data bus inversion bit, based on the determination to assert the plurality of new data bits and the data bus inversion bit closer to a bus idle value.

### FIELD OF THE INVENTION

The present invention relates generally to the transfer of information across a bus, more specifically to the manipulation of a data bus inversion bit for data being transmitted across the bus.

### BACKGROUND OF THE INVENTION

In a typical computing system, various components are connected together via a control bus and a data bus. The control bus signals the address type, type of transaction, such as a read or a write transaction, a data valid signal, and the data bus is used to transmit data values. Modem computing systems utilize a data bus inversion (DBI) bit for reducing the number of bit changes between consecutive data transmissions. A data transmission includes any type of data sent across the data bus, wherein the data includes one or more data values, typically either an on field, such as a one, and an off field, such as a 0. As the data bus sends different data across the bus, wherein each of the different data have different data values, the DBI bit is used to reduce the number of state changes between consecutive data values.

FIG. 1 illustrates a table representing a prior art DBI bit adjustment for different data fields having variant data values. The table 100 assumes an idle value 102 of [0000], wherein prior to transmitting a first data field 104, the data bus is set at the idle state 102. Therefore, when the data bus attempts to send the data field 104, [1000], across the data bus, a change bit value 106 is calculated, wherein a change bit value equals the total number of changes in states, or values, of the transmission data bits. A comparison of the idle value 102, [0000], and the first data field 104, [1000], produces a change bit value of 1. As such, a transmission value 108 is determined and transmitted across the data bus, wherein the transmission value 108 is the first data field 104 with the DBI bit 110 remaining set at 0, containing a plurality of current transmission data bits, each of the current transmission data bits having a current transmission data bit value, herein having four current transmission data bits having values of 1, 0, 0, and 0.

When a second data field 112 is to be transmitted across the data bus, the previous transmission value 108 [1000] is compared to the second data field 112, [1011], resulting in a change bit value of 2. In the prior art system, when the change bit value is equal to or greater than one-half of the data bus width, in the present example having a width of four bits for illustration purposes only, the new transmission value 108 [1011] is determined based on reducing the number of bits that are flipped, adjusted from an ON state to an OFF state or adjusted from an OFF state to an ON state. Therefore, the transmission value 108 is the same as the second data field 114, [1011], and the DBI bit 110 remains at 0.

When a third data value 114 [1111] is to be provided across the data bus, a change bit value 106 is determined relative to the second transmission value 108 [1011] previously sent across the data bus. A comparison of the second transmission value 108, [1011], and the third data field 114, [1111], reveals a change bit value of 1. In the prior art, when the change bit value is less than one-half of the data bus width, the DBI bit 110 is not adjusted and the transmission value, which is equal to the fourth data value 116, [1111], is transmitted across the data bus and the DBI bit 110 remains at 0.

A fourth data field 116, [1111], is provided to be transmitted across the data bus. Once again, comparison of the transmission value 108 with the fourth data field 116 reveals a change bit value of 0. Therefore, the transmission value 108 is the same as the fourth data field 116. As illustrated in the table 100, the data bus now returns to an idle 102 state, wherein the transmission value 108 is 0000 and the DBI 110 is also set to 0.

In the above example, the processing unit that transmits the data across the bus would have to perform a total of eight bit changes, where a single bit represents one of the individual data values, for example, the idle value includes four bits, 0000. The first bit change occurs when adjusting from the second data value to the third data value, two bit changes occur when adjusting from the third data value to the fourth data value, one bit change occurs when adjusting from the third data value to the fifth data value, and four bit changes occur when the bus goes to idle, in the last data value.

In another embodiment of a data bus inversion technique, the previous transmission is not included in the dbi bit inversion determination, but rather only a calculation of the number of data bit values in an ON is performed. When the number of data bit values in the ON state, such as a 1, is greater than one-half of the data bus width, the dbi bit is inverted. Otherwise, the data value is transmitted without inverting the dbi bit, in this prior art embodiment.

With every bit change, there exists electrical fluctuations as an electrical charge must be provided to represent the change from one state to another, illustrated as from a 1 to a 0 or from a 0 to a 1. As such, there exists a need for a way to reduce the number of bit changes through utilizing the DBI bit with respect to the data values to be transmitted across the data bus.

### BRIEF DESCRIPTION OF THE DRAWINGS

The invention will be more readily understood with reference to the following drawings wherein:

FIG. 1 is a table illustrating a prior art DBI adjustment technique;

FIG. 2 is a flowchart illustrating the steps of a method for data bus inversion, in accordance with one embodiment of the present invention;

FIG. 3 is a table illustrating the data bus inversion utilizing data value and a DBI bit, in accordance with one embodiment of the present invention;

FIG. 4 is a block diagram of a processing system having a memory and processor which execute the method for data bus inversion, in accordance with one embodiment of the present invention;

FIG. 5 is a logic circuit and block diagram of an apparatus for data bus inversion, in accordance with one embodiment of the present invention;

FIG. 6 is a flowchart illustrating the steps of a method for data bus inversion, in accordance with one embodiment of the present invention; and

FIG. 7 is a flowchart illustrating a method for data bus inversion, in accordance with another embodiment of the present invention.

### DETAILED DESCRIPTION OF A PREFERRED EMBODIMENT OF THE INVENTION

Generally, a method and apparatus for data bus inversion provides for a data bus having a data bus size value, wherein the data bus size value represents the number of bits transferred across the bus in a single transmission, for receiving a new data value having a plurality of new data bits. The method and apparatus further provide for determining the change bit value by comparing the different new data bits with a plurality of current transmitted data bits from a current data value. Furthermore, when the change bit value is equal to one-half the data bus size value, the method and apparatus provides for adjusting at least the plurality of new data bits and/or a data bus inversion bit, based on the determination to assert the plurality of new data bits and the data bus inversion bit closer to a bus idle value.

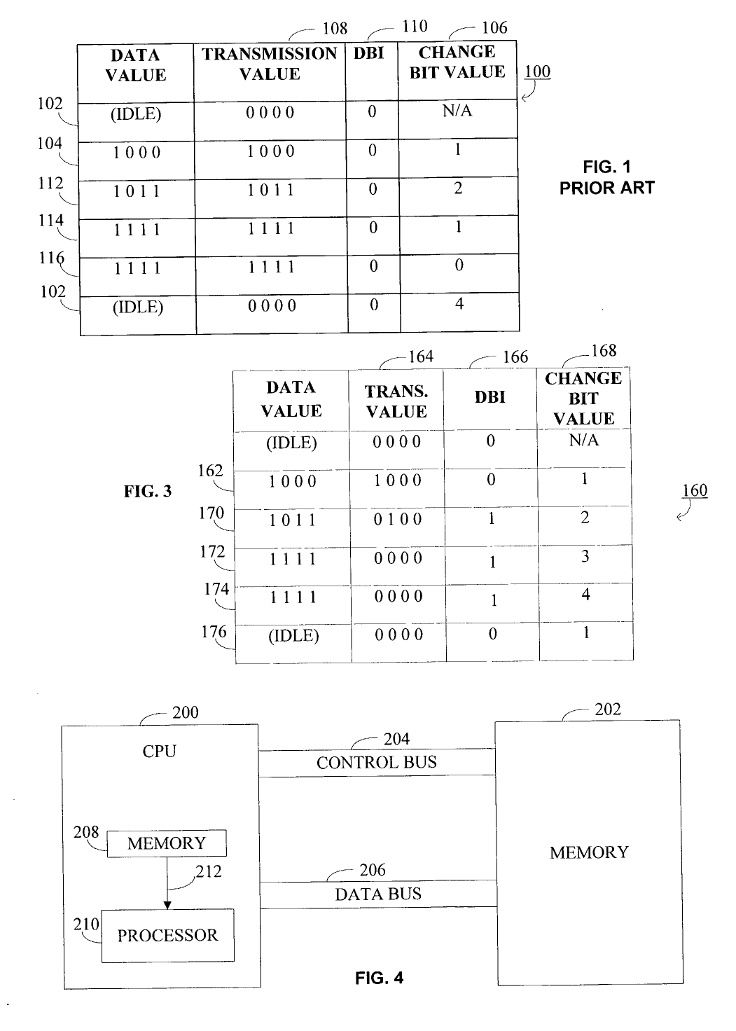

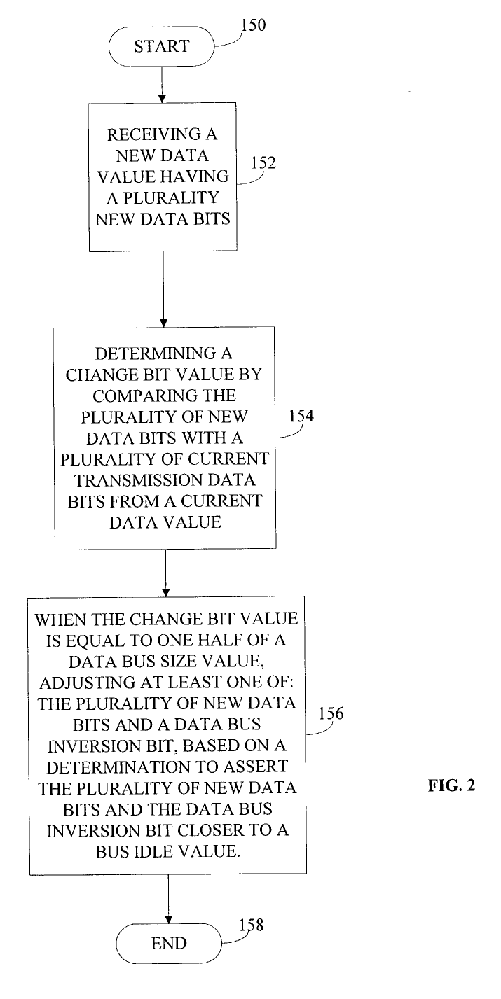

More specifically, FIG. 2 illustrates a flowchart representing the steps of the method for data bus inversion, in accordance with one embodiment of the present invention. The method begins, step 150, by receiving a new data value having a plurality of data bits, step 152. As discussed with respect to the table 160 of FIG. 3, a new data value includes any data value which is provided to a data bus for transmission thereacross, such as the new data value 162, data packet 1000. As discussed above with respect to FIG. 1, prior to receiving the first data value 162, the bus is at an idle state, having a transmission value 164 of [0000], and a DBI bit 166 set to 0.

The next step, 154, is determining a change bit value, such as a change bit value 168 of table 160, by comparing the plurality of new data bits, such as the individual data bits 1, 0, 0, 0 of data value 162, with a plurality of current transmission data bits from a current data value. The comparison occurs based on the transmitted value that previously was transmitted across a bus, regardless if the previous transmitted value was the same as or the inverse of the previous data, based on a set dbi bit. Using the example of the table 160, the current data value is the transmission value 164, also known as the idle value, and the current transmission data bits are 0, 0, 0, 0. Thereupon, in accordance with one embodiment of the present invention, when the change bit value, such as change bit value 168, is equal to one-half of a data bus size value, the method includes adjusting at least one of the plurality of new data bits and setting the DBI bit, such as DBI bit 166, based on the determination to assert the plurality of new data bits and the DBI bit closer to the bus idle value.

As illustrated with respect to the table 160, the first transmission value is the idle value 0000, but the second transmission value is represented as being the same as the new data value 162 since the change bit value 168 is 1. The table of FIG. 3 illustrates the data bus inversion method with respect to a four bit data bus, as recognized by one having ordinary skill in the art, the disposition of a four bit data bus is for illustration purposes only and is fully applicable to larger buses.

Step 156 of the flowchart of FIG. 2 is illustrated when a third data value 170, [1011], is provided to be transmitted across the four bit data bus. The change bit value 160 is calculated to have a value of 2 based on adjusting two of the data value bits of the third transmission data value with respect to the transmission value bits, more specifically the first and second bits which are adjusted from a 0 state to a 1 state. Therefore, in accordance with step 156, since the change bit value, 2, is equivalent to one-half of the data bus width, the transmission value 164 and the DBI bit 166 are adjusted to provide the transmission value 164 and DBI bit 166 as close to the idle value of 0000 as possible. Therefore, the DBI bit 166 is set and the transmission value is adjusted to be 0100. Thereupon, the method of FIG. 2 is complete, step 158.

To further illustrate the present invention, in comparison with the prior art table of FIG. 1, the same data packet, 112, and 170, are to be transmitted across the data bus, the prior art chose to not invert the DBI bit 110 and provided the data value to be equivalent to the third data field, 1011. Further benefits of the present invention will be seen through the continued analysis of the table 160 of FIG. 3. A fourth data field 172 is provided, having a value of [1111]. In accordance with known DBI inversion techniques, since the change bit value is greater than one-half of the data bus width, the DBI bit 166 is set to a value of 1, therefore providing the transmission value to be the inverse of the third data value 172, more specifically [0000]. Similar to the prior art table 100, a fifth data packet having a data value 174, [1111], is also provided to be transmitted across the data bus. Since the transmission value 164 from the previous transmission is equivalent to the fifth data value, 174, no resetting of the DBI bit nor adjustments of the bits of the transmission value are required. Next, when an idle value, 0000, 176 is provided to be transmitted across the data bus, the transmission value is already at the idle value, based on the previous transmission value from the fifth data value 174.

Thereupon, the method as described in FIG. 2, provides for a system having a reduced number of electrical transitions, otherwise known as bit changes, wherein the table 160 provides for a total of six bit changes as opposed to the eight bit changes required by the table of FIG. 1. The six bit changes are generated by one bit change being required for the transmission value 1000, three bit changes being generated for the generation of the transmission value of 0100 and the adjustment of the DBI bit 1, and two bit changes are required to adjust the transmission value to 0000 and the DBI bit back to a 0 value.

FIG. 4 illustrates a computer processing system, in accordance with one embodiment of the present invention. The processing system includes a central processing unit (CPU) 200 coupled to a memory 202, via a control bus 204 and a data bus 206. The CPU 200 also includes a memory 208 and a processor 210. The memory includes executable instructions 212 which are provided to the processor 210. The processor 210 may be, but is not limited to, a single processor, a plurality of processors, a DSP, a microprocessor, an application specific integrated circuit (ASIC), a state machine, or any other implementation capable of processing and executing software. The term processor should not be construed to refer exclusively to hardware capable of executing software, and may implicitly include DSP hardware, ROM for storing software, RAM, and any other volatile or non-volatile storage medium. The memory 208 having the executable instructions 212 stored therein, may be, but not limited to, a single memory, a plurality of memory locations, a shared memory, a CD, a DVD, a ROM, RAM, EPROM, optical storage, micro-code, or any other non-volatile storage capable of storing digital data for use by the processor 210. The processor 210, in response to the executable instructions 212, performs the operations as illustrated in FIG. 3. The processor 210, in response to the executable instructions 212, provides for adjustment of the DBI bit and the generation of a transmission value, such as 164, for transmission across the data bus 206, the memory 202, such that the transmission value and the DBI bit are as close as possible to a data bus 206 idle value, such as the value 0000.

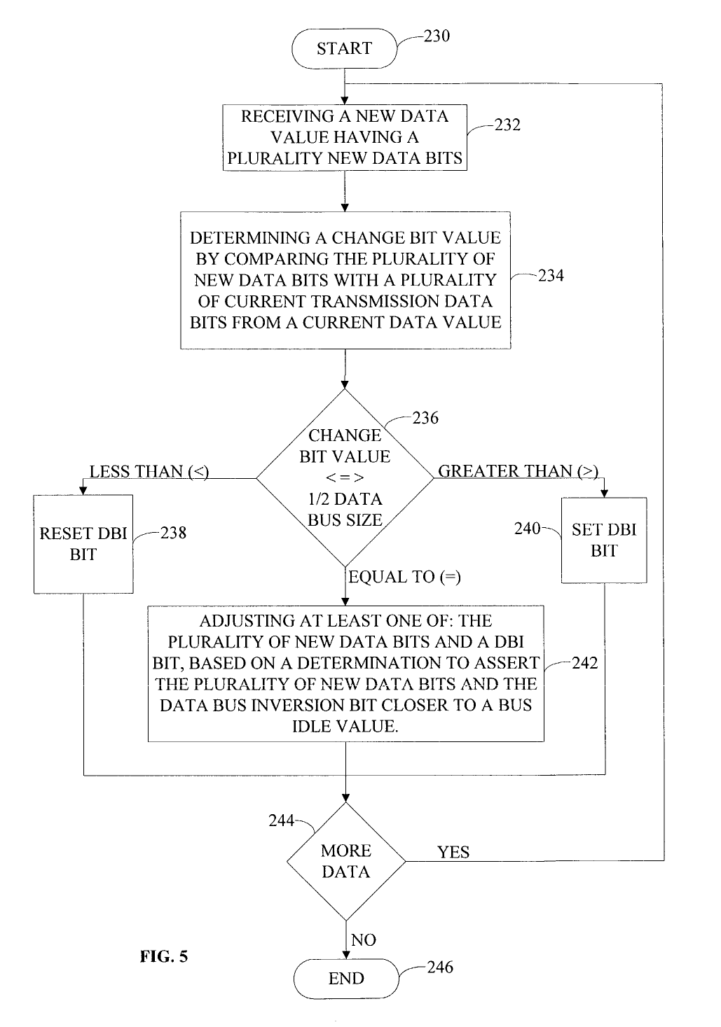

In one embodiment, the processor 210 executes the instructions as illustrated in the flowchart of FIG. 5. The process begins, step 230, by receiving the new data value having the plurality of new data bits, 232. Similar to the above discussion with respect to FIG. 3, the new data value 162 has a plurality of new data bits, more specifically illustrated having four separate data bits 1, 0, 0, 0. The next step as executed by the processor 210, in response to executable instructions 212, is to determine the change bit value by comparing the plurality of new data bits with the plurality of current transmission data bits from the current data value, step 234. As illustrated in FIG. 3, the current data value is an idle value having a plurality of current transmission data bits each having a data bit value of 0, and the DBI bit 166 also having a value of 0. Thereupon, a determination is made if the change bit value is greater than, equal to, or less than one-half of the data bus size, step 236. For example, FIG. 3 represents a data bus having a data bus size of four, therefore, the comparison is whether the change bit value is greater than, equal to, or less than the number 2.

As discussed above, when the change bit value is less than one-half of the data bus size, the DBI bit is reset and the new data value is the transmission value. Also, when the change bit value is greater than one-half of the data bus size, the DBI bit is set such that the inverse of the new data value is the transmission value, regardless of the value of the new data bits and the DBI bit with respect to an idle value.

In the event the change bit value is equal to one-half of the data bus size, the processor 208, in response to executable instructions 212, adjusts at least one of the plurality of new data bits or the DBI bit, based on a determination to assert the plurality of new data bits and the data bus inversion bit closer to the bus idle value, step 242. For example, as shown above in the table 160, when the change bit value 168 is equal to 2, the DBI bit 166 is inverted from a 0 state to a 1 state and the transmission value is adjusted from a 1000 to a 0100 to transmit the data value 1011 across the data bus 206. Thereupon, the transmission value includes a total of two data bit values which are different from an idle bit value, whereas the prior art system would have produced data transmitted across the data bus 206 having a total of 3 data bit values different from the idle bit value. Once the data has been transmitted across the bus 206, the determination is made whether there are more data values to be transmitted, step 244. If there are more data values, the processor reverts back to step 232 where the new data value becomes the current data value and the incoming data value becomes the new data value. Also, if no more data is to be provided across the data bus, the method is complete, step 246.

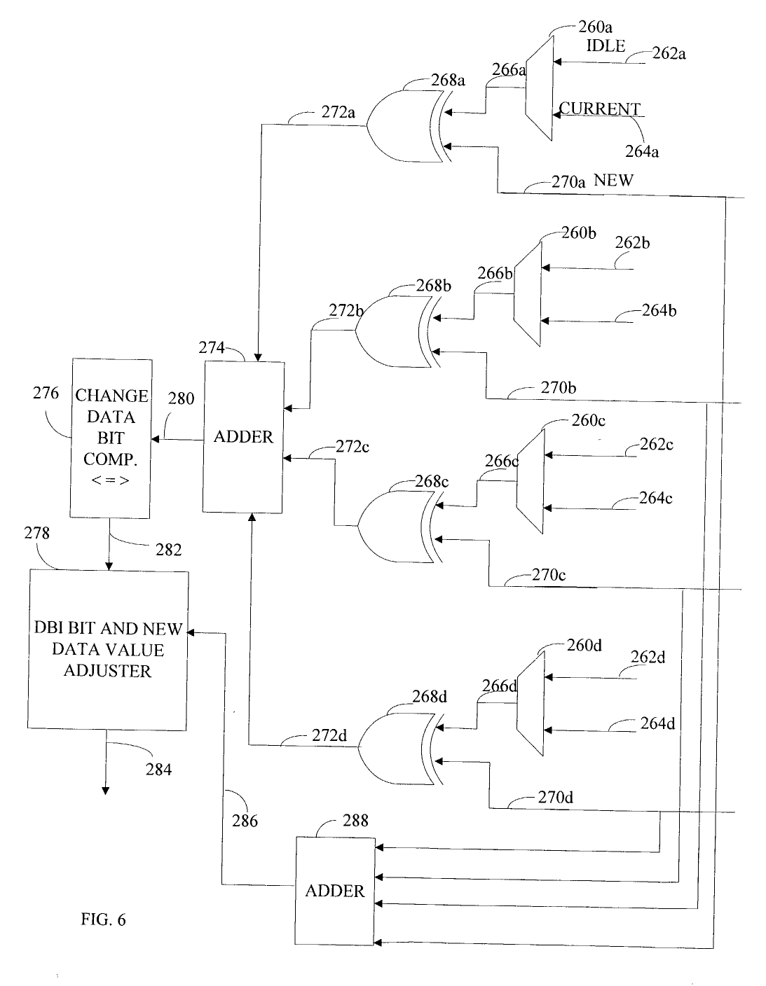

FIG. 6 illustrates a digital circuit and block diagram of an apparatus for data bus inversion, in accordance with one embodiment of the present invention. A plurality of multiplexers, 260A through 260D, which receive a current data value 260 and a new data value 264. As presently illustrated, FIG. 6 illustrates a system for use with a data bus having a width of four bits. As recognized by one having ordinary skill in the art, the number of multiplexers and incoming bit values are directly proportional, wherein a bus having a width of eight bits will have a total of eight multiplexers and a total of eight current bit value streams and eight new bit value streams. The multiplexers 260 receive each of the idle bit values 262 and the current transmission data bit values 264 and thereupon provide a multiplexed signal 266. Using the example of the idle state having four idle bites being [0,0,0,0] and current transmission data bits having four current data bit values of [1,0,1,0], the multiplexed signals 266 would be [1,0,1,0].

The multiplexed signals 266 are provided to an XOR gate 268 and a new bit value 270 is also provided to the XOR gate 268. The gate 268 thereupon produces an XOR signal 272 that is provided to an adder 274. The adder 274 adds the incoming XOR signals 272 to generate the previously discussed change bit value 168 (not illustrated). An adder output signal 280 is thereupon provided to a change data bit computational unit 276 which determines if the change bit value is greater than, less than, or equal to the data bus size value, wherein the adder output signal 280 includes the XOR signals 272 combined to create the new data value and the change bit value. The change data bit computational unit 276 operates in accordance with the above discussion, such as the discussion relating to FIG. 3

The change data bit computational unit 276 thereupon provides an output signal 282 to a data bus inversion bit and new data value adjuster 278, wherein the output signal includes an indication of whether to adjust the dbi bit and the new data value. The dbi bit and new data value adjuster also receives a new data bit value signal 286 from an adder 288. The adder 288 receives the same NEW signals, 270a-270d, and adds the number of ON bits, such as activated to a “1” state. The new data bit value signal 286 is thereupon utilized by the dbi bit and new data value adjuster 278 to determine to either adjusts the dbi bit and the new data value or maintain the dbi bit and the new data value in response to the change data bit computational unit 276. Thereupon, a transmission value 284 is generated and provided to be transmitted across a data bus.

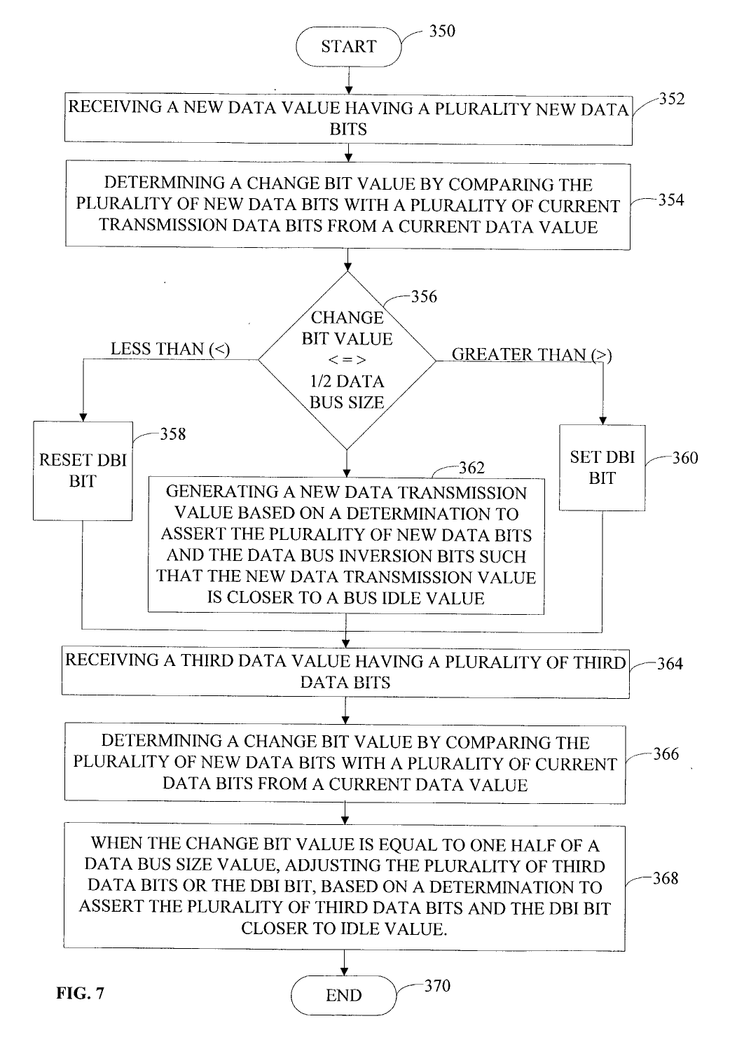

FIG. 7 is a flowchart representing the steps of a method for data bus inversion, in accordance with another embodiment of the present invention. The method begins, step 350, by receiving the new data value, such as data value 162, of table 160, having a plurality of new data bits, such as the bits 1, 0, 0, 0 of the data value 162, step 352. The next step, step 354, is determining the change bit value, such as change bit value 168, by comparing the plurality of new data bits, such as bits 1, 0, 0, 0 for the date value 162, with the plurality of current transmission data bits, such as the transmission value 164 bits 0, 0, 0, 0 from the current data value, also known as the transmission value. Similar to the method of FIG. 5, step 356, a determination is made if the change bit value is less than, equal to, or greater than one-half of the data bus size. If the change bit value is less than one-half of the data bus size, the DBI bit is reset, step 358, and the transmission value is the same as the data value. When the change bit value is greater than one-half of the data bus size, the DBI bit is set and the transmission value is the inverse of the new data value, such as the third data value 170 of table 160, 1011, wherein the transmission value is 0100 and the DBI bit 168 is 1, step 360.

In the event the change bit value is equal to one-half the data bit size, a new data transmission value is generated based on a determination to assert the plurality of new data bits and the data bus inversion bit such that the new data transmission value is closer to a bus idle value, step 362. The next step, 364, is receiving a third data value having a plurality of third data bits. Thereupon, determination of the change bit value is made by comparing the plurality of new data bits with the plurality of current transmission data bits from the current data value, wherein the original new data value has now become the current data value, step 366. Thereupon, when the change bit value is equal to one-half of the data bus size value, the plurality of third data bits are adjusted or the DBI bit is adjusted, based on a determination to assert the plurality of third data bits and the DBI bit closer to an idle value, step 368. As such, the method is complete, step 370.

The present invention, as disclosed herein, provides an improved method and apparatus for data bus inversion by adjusting the new data bit values and the DBI bit with respect to idle bit values. The method and apparatus also generates a transmission value for transmission across a data bus, whereupon the method and apparatus operate to provide an overall reduction in the number of bit changes required for a series of data transmissions. Therefore, as the number of bit transitions are reduced, electrical fluctuations and other problems associated therewith are thereby reduced, thus producing a more efficient and higher quality computing system.

It should be understood that the implementation of other variations and modifications of the invention in its various aspects will be apparent to those of ordinary skill in the art, and that the invention is not limited by the specific embodiments described. For example, the data bus inversion method and apparatus may be utilized between any two electrical or computational components such that a data bus itself has reduced number of electrical fluctuations. The method and apparatus is not so limited herein as being only disposed between a CPU, such as CPU 200, such as memory 202, but may be readily implemented with regards to any other processing system which utilizes transmission of data across a data bus, such as data bus 206. It is therefore contemplated to cover by the present invention, any and all modifications, variations, or equivalents that fall within the spirit and scope of the basic underlying principles disclosed and claimed herein.

What is claimed is:

1. A method for data bus inversion on a data bus having a data bus size value, wherein the data bus size value represents the number of bits transferred across the bus in a single transmission, the method comprising:
receiving a new data value having a plurality new data bits;
determining a change bit value by comparing the plurality of new data bits with a plurality of current transmission data bits from a current data value; and
when the change bit value is equal to one half of the data bus size value, adjusting at least one of: the plurality of new data bits and a data bus inversion bit, based on a determination to assert the plurality of new data bits and the data bus inversion bit closer to a bus idle value.

2. The method of claim 1 further comprising:
when the change bit value is less than one half of the data bus size value, maintaining the data bus inversion bit; and
when the change bit value is greater than one half of the data bus size value, adjusting the data bus inversion bit.

3. The method of claim 1 wherein the number of the plurality of new data bits is equivalent to the data bus size value and the number of the plurality of current transmission data bits is equivalent to the data bus size value such that each of the plurality of new data bits has a data bit value and each of the plurality of current transmission data bits has a current transmission data bit value and each one of the plurality of new data bits corresponds to each one of the plurality of plurality of current data bits.

4. The method of claim 3, the step of determining a change bit value further comprises:
comparing each one of the new data bit values for each of the plurality of new data bits to the corresponding each one of the current transmission data bit values of the plurality of current transmission data bits; and
incrementing the change bit value when each one of the new data bit values is not equal to the corresponding one of the current transmission data bit values.

5. The method of claim 1 wherein the bus idle value includes a plurality of idle bits having an idle bit value equal to an idle value and an idle data bus inversion bit having an idle data bus inversion bit value equal to the idle value.

6. The method of claim 5 wherein the idle value is a low value.

7. A method for data bus inversion on a data bus having a data bus size value, wherein the data bus size value represents the number of bits transferred across the bus in a single transmission, the method comprising:
receiving a new data value having a plurality new data bits;
determining a change bit value by comparing the plurality of new data bits with the plurality of current transmission data bits from a current data value;
when the change bit value is equal to one half of the data bus size value, generating a new data transmission value based on a determination to assert the plurality of new data bits and the data bus inversion bit such that the new data transmission value is closer to a bus idle value;
when the change bit value is less than one half of the data bus size value, generating the new data transmission value by resetting the data bus inversion bit; and
when the change bit value is greater than one half of the data bus size value, setting the data bus inversion bit.

8. The method of claim 7 wherein the new data transmission value includes the new data value and the data bus inversion bit when the data bus inversion bit has a first value and the new data transmission value includes the inverse of the new data value and the data bus inversion bit when the data bus inversion bit has a second value.

9. The method of claim 7 wherein the number of the plurality of new data bits is equivalent to the data bus size value and the number of the plurality of current transmission data bits is equivalent to the data bus size value such that each of the plurality of new data bits has a data bit value and each of the plurality of current transmission data bits has a current transmission data bit value and each one of the plurality of new data bits corresponds to each one of the plurality of plurality of current data bits.

10. The method of claim 9, the step of determining a change bit value further comprises:
comparing each one of the new data bit values for each of the plurality of new data bits to the corresponding each one of the current transmission data bit values of the plurality of current transmission data bits; and
incrementing the change bit value when each one of the new data bit values is not equal to the corresponding one of the current transmission data bit values.

11. The method of claim 7 wherein the bus idle value includes a plurality of idle bits having an idle bit value equal to an idle value and an idle data bus inversion bit having an idle data bus inversion bit value equal to the idle value.

12. The method of claim 7 further comprising:
receiving a third data value having a plurality third data bits;
determining a second change bit value by comparing the plurality of third data bits with the plurality of new transmission data bits;
when the second change bit value is equal to one half of the data bus size value, generating a second data transmission value based on a determination to assert the plurality of second data bits and the data bus inversion bit such that the second data transmission value is closer to the bus idle value.

13. The method of claim 12, further comprising:
when the second change bit value is less than one half of the data bus size value, generating the second data transmission value by maintaining the data bus inversion bit; and
when the second change bit value is greater than one half of the data bus size value, adjusting the data bus inversion bit.

14. The method of claim 7 wherein the idle value is a low value.

15. An apparatus for dynamic bus inversion on a data bus having a data bus size value, wherein the data bus size value represents the number of bits transferred across the bus in a single transmission, the apparatus comprising:
at least one processor; and
at least one memory device, coupled to the at least one processor, having stored executable instructions that, when executed by the at least one processor, cause the at least one processor to:
receive a new data value having a plurality new data bits;
determine a change bit value by comparing the plurality of new data bits with a plurality of current transmission data bits from a current data value; and
when the change bit value is equal to one half of the data bus size value, adjust at least one of: the plurality of new data bits and a data bus inversion bit, based on a determination to assert the plurality of new data bits and the data bus inversion bit closer to a bus idle value.

16. The apparatus of claim 15 wherein the executable instructions stored within the at least one processor further cause the at least one processor to:
when the change bit value is less than one half of the data bus size value, maintain the data bus inversion bit; and
when the change bit value is greater than one half of the data bus size value, adjust the data bus inversion bit.

17. The apparatus of claim 15 wherein the number of the plurality of new data bits is equivalent to the data bus size value and the number of the plurality of current transmission data bits is equivalent to the data bus size value such that each of the plurality of new data bits has a data bit value and each of the plurality of current transmission data bits has a current transmission data bit value and each one of the plurality of new data bits corresponds to each one of the plurality of current data bits.

18. The apparatus of claim 17 wherein the executable instructions stored within the at least one processor further cause the at least one processor to:
compare each one of the new data bit values for each of the plurality of new data bits to the corresponding each one of the current transmission data bit values of the plurality of current transmission data bits; and
increment the change bit value when each one of the new data bit values is not equal to the corresponding one of the current transmission data bit values.

19. The apparatus of claim 15 wherein the bus idle value includes a plurality of idle bits having an idle bit value equal to an idle value and an idle data bus inversion bit having an idle data bus inversion bit value equal to the idle value.
